(19) United States
(12) Patent Application Publication
(10) Pub. No.: US 2021/0030016 A1
(43) Pub. Date: Feb. 4, 2021

(54) TREATED PLANT MATERIAL AND METHODS FOR MAKING AND USING THE SAME

(71) Applicant: Givaudan SA, Vernier (CH)

(72) Inventors: Guiseppe CORDA, Lelystad (NL); Frans WITTEVEEN, Leusden (NL)

(21) Appl. No.: 16/959,404

(22) PCT Filed: Jan. 21, 2019
(86) PCT No.: PCT/EP2019/051324

§ 371 Date: Jun. 30, 2020

Related U.S. Application Data
(60) Provisional application No. 62/620,277, filed on Jan. 22, 2018.

(51) Int. Cl. A23F 3/14; A23L 33/15; A23L 33/16; A23L 33/105; A23F 3/22; A23F 3/32

(52) U.S. Cl. CPC A23F 3/14; A23L 33/15; A23F 3/32; A23L 33/105; A23F 3/22; A23L 33/16

(57) ABSTRACT

Disclosed is a plant material having at least one exogenous vitamin and/or at least one exogenous mineral added to the plant material and at least partially contained within the plant material. The at least one exogenous vitamin and/or at least one exogenous mineral may be at least partially encapsulated within one or more pores of the plant material. The at least one exogenous vitamin and/or at least one exogenous mineral may be at least partially located within one or more fractures in the plant material. Also provided are methods for at least partially containing at least one exogenous vitamin and/or at least one exogenous mineral within a plant material. The present disclosure also relates to methods of using plant material having at least one exogenous vitamin and/or at least one exogenous mineral at least partially contained therein to make a consumable.

### TECHNICAL FIELD

The present disclosure relates to a plant material having at least one exogenous vitamin and/or at least one exogenous mineral at least partially contained within the plant material. According to certain illustrative embodiments, the disclosure relates to a plant material having at least one exogenous vitamin and/or at least one exogenous mineral at least partially encapsulated and/or at least partially located within the plant material. Also provided are methods for at least partially containing at least one exogenous vitamin and/or at least one exogenous mineral within a plant material. The present disclosure also relates to methods of using plant material having at least one exogenous vitamin and/or at least one exogenous mineral at least partially contained therein to make a consumable.

### BACKGROUND

Treating the exterior surface of plant material with a coating of an exogenous material can result in various problems. One such problem is that topical coatings are susceptible to degradation through exposure to the environment. Furthermore, once topically coated onto the exterior surface of plant material, the exterior surface of plant material may lose some of the coating over time due to friction with other plant material, or through contact with packaging materials. Topical coatings may also discolor the plant material making it appear unattractive or unnatural to a potential purchaser. Topical coatings typically involve flavoring and/or nutrient variations due to improper coating levels. The foregoing problems are avoided in certain instances by at least partially containing at least one exogenous vitamin and/or at least one exogenous mineral within the interior of the plant material. It is therefore desirable to provide a plant material comprising at least one exogenous vitamin and/or at least one exogenous mineral at least partially contained therein and methods for making and using the same.

### SUMMARY

Disclosed is a plant material having at least one exogenous vitamin and/or at least one exogenous mineral at least partially contained therein. Also disclosed is a plant material having at least one exogenous vitamin and/or at least one exogenous mineral at least partially encapsulated and/or at least partially located therein. Also disclosed is a consumable comprising the plant material or an extract of the plant material, wherein the plant material includes at least one exogenous vitamin and/or at least one exogenous mineral at least partially contained therein. Also disclosed is a granulated plant material having at least one exogenous vitamin and/or at least one exogenous mineral at least partially encapsulated in one or more pores of the plant material and/or at least partially located within the plant material.

Also disclosed are methods for making a plant material having at least one exogenous vitamin and/or at least one exogenous mineral at least partially contained therein. According to certain embodiments the method comprises opening one or more pores of the plant material, contacting the plant material with at least one exogenous vitamin and/or at least one exogenous mineral to permit the at least one exogenous vitamin and/or at least one exogenous mineral to enter at least a portion of one or more of the opened pores of the plant material, and closing one or more of the opened pores to at least partially encapsulate the at least one exogenous vitamin and/or at least one exogenous mineral within one or mote of the pores of the plant material.

Alternatively or additionally, the method may comprise contacting the plant material with at least one exogenous vitamin and/or at least one exogenous mineral to permit the at least one exogenous vitamin and/or at least one exogenous mineral to enter at least a portion of the plant material. In certain embodiments, the at least one exogenous vitamin and/or at least one exogenous mineral enters the interior of the plant material through one or more fractures on the plant material surface.

Also disclosed are methods for at least partially locating at least one exogenous vitamin and/or at least one exogenous mineral within a plant material comprising creating one or more fractures on the plant material and contacting the plant material with at least one exogenous vitamin and/or at least one exogenous mineral to permit the at least one exogenous vitamin and/or at least one exogenous mineral to enter one or more fractures in the plant material.

Also disclosed are methods tor making a beverage from a product, wherein the product comprises a plant material having at least one exogenous vitamin and/or at least one exogenous mineral at least partially contained therein, wherein the method comprises infusing the product in a liquid.

Also disclosed are methods for making a beverage from a product, wherein the product comprises a plant material having at least one exogenous vitamin and/or at least one exogenous mineral at least partially contained therein, wherein the method comprises creating one or more fractures on the plant material and contacting the plant material with at least one exogenous vitamin and/or at least one exogenous mineral to permit the at least one exogenous vitamin and/or at least one exogenous mineral to at least partially enter one or more fractures on the plant material.

Also disclosed is an infusion packet for making a beverage, wherein the infusion packet contains a plant material having at least one exogenous vitamin and/or at least one exogenous mineral at least partially contained therein. In certain embodiments, the infusion packet is contacted with a liquid to extract the at least one exogenous vitamin and/or at least one exogenous mineral from the plant material.

Also disclosed is a beverage pod, cartridge, cup or capsule containing plant material having at least one exogenous vitamin and/or at least one exogenous mineral at least partially contained therein.

### BRIEF DESCRIPTION OF THE DRAWINGS

FIG. 1A is a scanning electron microscope (SEM) image of the surface of a tea leaf from the Camellia sinensis plant having exogenous vitamins contained within the cell interiors of the tea leaf resulting in the smooth appearance of the leaf surface.

FIG. 1B is a comparative SEM image of the surface of a tea leaf from the Camellia sinensis plant devoid of exogenous vitamins within the tea leaf resulting in the rough, uneven appearance of the leaf surface.

FIG. 2A is a SEM cross section image of a tea leaf from the Camellia sinensis plant having exogenous vitamins at least partially encapsulated in pores of the tea leaf (vitaminized leaf). The pore cavities are not visible because the cavities are filled with vitamins.

FIG. 2B is a comparative SEM cross section image of a tea leaf from the Camellia sinensis plant devoid of exogenous vitamins within the pores of the tea leaf. The pore cavities are visible because the cavities are not filled with vitamins.

### DETAILED DESCRIPTION

Disclosed is plant material having at least one exogenous vitamin and/or at least one exogenous mineral added to the plant material and that is at least partially contained within the plant material. According to certain illustrative embodiments, the plant material has at least one exogenous vitamin and/or at least one exogenous mineral at least partially encapsulated and/or at least partially located therein.

According to certain illustrative embodiments, the plant material comprises at least one exogenous vitamin and/or at least one exogenous mineral at least partially encapsulated in one or more pores of the plant material.

According to certain illustrative embodiments, the plant material comprises at least one leaf and/or at least one leaf stem. According to certain illustrative embodiments, the plant material comprises at least one tea leaf and/or at least one tea leaf stem. According to certain illustrative embodiments, the at least one tea leaf and/or at least one tea leaf stem is obtained from the Camellia sinensis plant.

According to certain illustrative embodiments, the plant material containing the exogenous vitamin and/or mineral is substantially dehydrated or dried. According to certain illustrative embodiments, the plant material containing the exogenous vitamin and/or mineral is dried to a moisture content of about 30 weight percent or less. According to certain illustrative embodiments, the plant material containing the exogenous vitamin and/or mineral is dried to a moisture content of about 20 weight percent or less. According to certain illustrative embodiments, the plant material containing the exogenous vitamin and/or mineral is dried to a moisture content of about 10 weight percent or less. According to certain illustrative embodiments, the plant material containing the exogenous vitamin and/or mineral is dried to a moisture content of about 5 weight percent or less.

According to certain illustrative embodiments, the plant material may comprise any variety of tea leaf material or combinations thereof, such as, without limitation, black tea. Echinacea tea, oolong tea, green tea, hibiscus tea, yellow tea, white tea, or combinations thereof. Green tea leaves refer to substantially unfermented tea leaves. Black tea leaves refer to substantially fermented tea leaves. Oolong tea leaves refer to partially fermented tea leaves. The plant material may be oxidized, semi-oxidized and/or non-oxidized.

According to certain illustrative embodiments, the plant material comprises herb plant material. The expression “herb plant material” refers to material which is commonly used as a precursor for herbal infusions. Without limitation, the herb plant material may comprise chamomile, elderflower, hibiscus, jasmine, lavender, lemongrass, mint, rooibos, verbena or combinations thereof.

According to certain illustrative embodiments, the plant material comprises fruit pieces such as apple, blackcurrant, mango, peach, pineapple, raspberry or strawberry.

According to certain illustrative embodiments, the plant material comprises tea. vegetables, fruit pieces, medicinal plants, herbs, spices or combinations thereof.

The at least one exogenous vitamin may comprise any known fat-soluble vitamin. The fat-soluble vitamin may comprise vitamin A, D, E and/or K, including analogues or derivatives thereof.

The at least one exogenous vitamin may also comprise any water-soluble vitamin. The water-soluble vitamin may comprise vitamin B and/or K, including analogues or derivatives thereof.

According to certain illustrative embodiments, the at least one exogenous vitamin may comprise a mixture of at least one fat-soluble vitamins and at least one water-soluble vitamins. According to certain illustrative embodiments, the at least one exogenous vitamin comprises a blend of Vitamin E, Vitamin B1, Vitamin B2, Vitamin B6, Vitamin B9, Vitamin B12, Vitamin C, niacinamide, pantothenic acid and biotin. According to certain illustrative embodiments, the at least one exogenous vitamin comprises at least one of Vitamin D3, Vitamin E, Thiamine, Riboflavin, Niacin, Pantothenic acid, pyridoxine, biotin, folic acid or ascorbic acid.

Without limitation, the at least one exogenous mineral may comprise calcium, sodium, iodine, chloride, boron, potassium, phosphorous, magnesium, manganese, copper, zinc, iron, nickel, tin, vanadium, silicon, selenium, chromium, molybdenum or combinations thereof.

According to certain illustrative embodiments, the at least one exogenous vitamin and/or at least one exogenous mineral is dry. As used in this context, “dry” refers to at least one exogenous vitamin and/or at least one exogenous mineral having a moisture content of less than about 10 weight percent less than about 7 weight percent, less than about 5 weight percent, or less than about 3 weight percent. According to certain illustrative embodiments, a dry vitamin complex is used. According to certain illustrative embodiments, the at least one dry exogenous vitamin and/or at least one dry exogenous mineral is contacted with plant material until from about 1 to about 25 weight percent of the plant material has at least one exogenous vitamin and/or at least one exogenous mineral at least contained therein.

According to certain illustrative embodiments, the plant material comprises about 50 weight percent or less of the at least one exogenous vitamin and/or at least one exogenous mineral at least partially contained therein. According to certain illustrative embodiments, the plant material comprises about 40 weight percent or less of the at least one exogenous vitamin and/or at least one exogenous mineral at least partially contained therein. According to certain illustrative embodiments, the plant material comprises about 30 weight percent or less of the at least one exogenous vitamin and/or at least one exogenous mineral at least partially contained therein. According to certain illustrative embodiments, the plant material comprises about 20 weight percent or less of the at least one exogenous vitamin and/or at least one exogenous mineral at least partially contained therein. According to certain illustrative embodiments, the plant material comprises about 15 weight percent or less of the at least one exogenous vitamin and/or at least one exogenous mineral at least partially contained therein. According to certain illustrative embodiments, the plant material comprises about 10 weight percent or less of the at least one exogenous vitamin and/or at least one exogenous mineral at least partially contained therein. According to certain illustrative embodiments, the plant material comprises about 5 weight percent or less of the at least one exogenous vitamin and/or at least one exogenous mineral at least partially contained therein. According to certain illustrative embodiments, the plant material comprises from about 1 to about 15 weight percent or less of the at least one exogenous vitamin and/or at least one exogenous mineral at least partially contained therein. According to certain illustrative embodiments, the plant material comprises from about 5 to about 15 weight percent or less of the at least one exogenous vitamin and/or at least one exogenous mineral at least partially contained therein. According to certain illustrative embodiments, the plant material comprises from about 5 to about 10 weight percent or less of the at least one exogenous vitamin and/or at least one exogenous mineral at least partially contained therein. According to certain illustrative embodiments, the plant material comprises from about 1 to about 10 weight percent or less of the at least one exogenous vitamin and/or at least one exogenous mineral at least partially contained therein. According to certain illustrative embodiments, the plant material comprises from about 1 to about 7.5 weight percent or less of the at least one exogenous vitamin and/or at least one exogenous mineral at least partially contained therein. According to certain illustrative embodiments, the plant material comprises from about 1 to about 5 weight percent or less of the at least one exogenous vitamin and/or at least one exogenous mineral at least partially contained therein. According to certain illustrative embodiments, the plant material comprises from about 0.1 to about 5 weight percent or less of the at least one exogenous vitamin and/or at least one exogenous mineral at least partially contained therein. According to certain illustrative embodiments, the plant material comprises from about 2 to about 15 weight percent or less of the at least one exogenous vitamin and/or at least one exogenous mineral at least partially contained therein. According to certain illustrative embodiments, the plant material comprises from about 3 to about 15 weight percent or less of the at least one exogenous vitamin and/or at least one exogenous mineral at least partially contained therein. According to certain illustrative embodiments, the plant material comprises from about 4 to about 15 weight percent or less of the at least one exogenous vitamin and/or at least one exogenous mineral at least partially contained therein. According to certain illustrative embodiments, the plant material comprises from about 5 to about 15 weight percent or less of the at least one exogenous vitamin and/or at least one exogenous mineral at least partially contained therein. The above weight percentages are based on the total weight percent of the final treated plant material.

The at least one exogenous vitamin and/or at least one exogenous mineral may be at least partially contained within the plant material, in a nutritionally effective amount. The expression “nutritionally effective amount” as used herein means that the amount of the at least one exogenous vitamin and/or at least one exogenous mineral at least partially contained within the plant material, is of a sufficient quantity to achieve the intended purpose, such as to provide a vitamin and/or mineral supplement. A nutritionally effective amount of at least one exogenous vitamin and/or at least one exogenous mineral per body weight of a subject can be determined by one having ordinary skill in the art without having to resort to undue experimentation.

As used herein, the term “exogenous” refers to any material that is added to plant material. Without limitation, exogenous material may include at least one vitamin, mineral, polyphenol, antioxidant, enzyme, polymer, carbohydrate, protein, amino acid, sugar, lipid, nucleic acid or combinations thereof.

As used herein, the expression “fully encapsulated” refers to material that is completely surrounded or enclosed within one or more pores of a plant material. As used herein, the expression “partially encapsulated” refers to material that is at least partially surrounded or enclosed within one or more pores of a plant material.

In the present disclosure, the term “about” used in connection with a quantity is inclusive of the stated value and has the meaning dictated by the context. For example, it includes at least the degree of error associated with the measurement of the particular quantity. One of skill in the art would understand the term “about” is used herein to mean that an amount of “about” a recited percentage (%) produces the desired degree of effectiveness in the compositions and methods of the present disclosure. One of skill in the art would further understand that the metes and bounds of “about” with respect to the quantity of any component in an embodiment can be determined by varying the quantity of one or more components, determining the effectiveness of the mixture for each concentration, and determining the range of concentrations that produce mixtures with the desired degree of effectiveness in accordance with the present disclosure. The term “about” is further used to reflect the possibility that a mixture may contain trace components of other materials that do not alter the effectiveness or safety of the mixture.

It should be understood that when an amount or concentration range is described in the present disclosure, it is intended that any and every amount or concentration within the range, including the end points, is to be considered as having been stated. For example, “a range of from 1 to 10” is to be read as indicating each and every possible number along the continuum between 1 and 10. It is to be understood that the inventors appreciate and understand that any and all data points within the range are to be considered to have been specified, and that the inventors have possession of the entire range and all points within the range.

According to certain illustrative embodiments, a plant material comprising at least one exogenous vitamin and/or at least one exogenous mineral at least partially contained therein is contacted with a liquid to provide a beverage. According to certain illustrative embodiments, the method includes infusing a liquid with the treated plant material. The term “infusing” refers to steeping, brewing and/or soaking a plant material in a liquid, typically water in order to extract desirable substances such as flavors and/or biochemically active agents from the plant material. The infusing method can be earned out at any desired temperature. According to certain illustrative embodiments, the infusing method is carried out in a hot liquid. In this context, the term “hot” refers to temperatures from about 60° C. to about 200° C.

A beverage is defined as a drinkable composition which is suitable for human and/or animal consumption. According to certain illustrative embodiments, drinkable compositions are substantially aqueous. According to certain illustrative embodiments, the beverage comprises at least about 60 weight percent water. According to certain illustrative embodiments, the beverage comprises at least about 70 weight percent water. According to certain illustrative embodiments, the beverage comprises at least about 80 weight percent water. According to certain illustrative embodiments, the beverage comprises at least about 90 weight percent water. According to certain illustrative embodiments, the beverage comprises from about 95 to about 99 weight percent water. The above weight percentages are based on the total weight percent of the beverage.

Also disclosed are methods for producing a plant material for making a consumable such as a vitamin-enhanced and/or mineral-enhanced tea product. As used herein, the term “consumable” refers to products for consumption by a subject for at least one of the purposes of enjoyment, nourishment, or health and wellness benefits. The term also refers to, for example, dietary and/or nutritional supplements. Consumables include, but are not limited to, foodstuffs of all kinds, beverages, nutraceuricals and pharmaceuticals. Exemplary beverages include, but are not limited to, flavoured water, soft drinks, fruit drinks, tea-based drinks, juice-based drinks (includes fruit and vegetable), carbonated or non-carbonated drinks, powdered drinks and alcoholic or non-alcoholic drinks.

According to certain illustrative embodiments, the method comprises opening one or more pores of the plant material, contacting the plant material with at least one exogenous vitamin and/or at least one exogenous mineral to permit the at least one exogenous vitamin and/or at least one exogenous mineral to enter at least a portion of one or more of the opened pores of the plant material, and closing the one or more of the opened pores to at least partially encapsulate the at least one exogenous vitamin and/or at least one exogenous mineral within the one or more of the pores of the plant material.

As used herein, the term “opening” the pores of a plant material means increasing the aperture size of one or more pores sufficiently to allow for passage of at least one exogenous vitamin and/or at least one exogenous mineral into at least a portion of one or more pores of the plant material. The one or more pores of the plant material may include substomatal cavities of the plant material. These openings can be sealed after absorption and drying. As used herein, the expression “closing” the pores of a plant material means decreasing the aperture size of one or more pores sufficiently to prevent or reduce the at least one exogenous vitamin and/or at least one exogenous mineral from escaping one or more pores of a dry plant material.

The at least one exogenous vitamin and/or at least one exogenous mineral can also enter the leaves through one or more fractures in the leaf surface. In certain embodiments, the fracture is produced by size reduction and/or drying processes, such as the size reduction and drying processes disclosed herein. Alternatively or additionally, the fractures in the leaf surface may be naturally present. According to embodiments wherein the tea leaves are sheared into small pieces before application of the at least one exogenous vitamin and/or at least one exogenous mineral, the at least one exogenous vitamin and/or at least one exogenous mineral can enter leaf interiors through gross factures created during the size reduction process, for example, during a shearing process.

According to certain illustrative embodiments, the size of the plant material is first reduced. This is accomplished by any known process for reducing the size of a material. For example, and without limitation, the size of the plant material may be reduced by granulating, mixing, grinding, grating, shredding, mincing, crushing, crumbling, comminuting, pulverizing, stirring, milling, macerating, rolling, blending and like processes.

According to certain illustrative embodiments, a sufficient amount of plant material is subjected to a size reduction step by introducing the plant material into a granulator or mixer.

Any mixer or granulator which provides shear may be employed in the method. As used herein, “shearing” or “high shear” refers to rapid agitation of plant material in order to provide granulated plant material having a desired average size. Shearing can be provided by fast moving mixer blades or having high blade tip speeds. The shearing step may be carried out under any desired temperature and/or speed. According to certain embodiments, the speed of the agitator is from about 10 to about 1000 rpm. According to certain embodiments, the speed of the agitator is from about 50 to about 500 rpm. According to certain embodiments, the speed of the agitator is from about 100 to about 250 rpm. According to certain embodiments, the speed of the chopper is from about 10 to about 1000 rpm. According to certain embodiments, the speed of the chopper is from about 50 to about 500 rpm. According to certain embodiments, the speed of the chopper is from about 100 to about 400 rpm. According to certain illustrative embodiments, the granulator comprises a vertical and/or a horizontal high shear granulator. A suitable high shear vertical granulator such as the Glatt-Powrex Vertical Granulator is commercially available from The Glatt Group (Binzen, Germany). Without limitation, examples of suitable granulation methods include spray-drying, freeze-drying, fluidized bed granulation and tumbling granulation. The granulation can be conducted by using two or more granulation methods in combination.

The average size of the granulated plant material may be from about 10 μm to about 7,000 μm. According to certain illustrative embodiments, the granulated plant material is from about 100 μm to about 5,000 μm. According to certain illustrative embodiments, the granulated plant material is from about 250 μm to about 2,000 μm According to certain illustrative embodiments, at least 50 weight percent of the granulated plant material has an average particle size of about 100 μm to about 3000 μm. It is to be noted that the term “average particle size” as used herein means a value as measured in accordance with ISO 13322-1/2 for image analyses standards.

According to certain illustrative embodiments, opening thee one or more pores of the plant material comprises contacting the plant material with a liquid. According to certain illustrative embodiments, the liquid may be selected from water, at least one solvent, at least one carrier, or combinations thereof. According to certain illustrative embodiments, the liquid comprises an aqueous dispersion. An “aqueous dispersion” refers to particles distributed throughout a medium of liquid water, e.g., as a suspension, a colloid, an emulsion, a sol, etc. The medium of liquid water may be pure water, or may be a mixture of water with at least one solvent, at least one additive and/or or at least one carrier, in certain embodiments, the liquid medium comprises triacetin.

Stomata are pores found in the epidermis of leaves, stems and other plant organs that facilitate gas exchange. The pore is bordered by a pair of specialized parenchyma ceils known as guard cells that are responsible for regulating the size of the stomatal opening. Without being bound to any particular theory, it is believed that stomata open in response to increases in the osmolality of the guard cells. These increases in osmolality are followed by the movement of water into the guard cells, which increases their volume and opens the stomata. Stomatal closure occurs in the opposite manner, as the osmolality of guard cells is reduced, their volume decreases. Disclosed are methods for controlling stomatal opening and closure for purposes of at least partially encapsulating at least one exogenous vitamin and/or at least one exogenous mineral in one or more pores of a plant material.

According to certain illustrative embodiments, without being bound to any particular theory, opening the pores of the plant material includes increasing the volume of guard cells by transport of liquid across the guard cell membrane. The liquid acts to increase the volume of the guard cells which opens the stomata, allowing for greater stomatal conductance. According to certain illustrative embodiments, the liquid is sprayed onto the plant material to increase the volume of the guard cells to open the stomata. The size of the stomata aperture may be opened by other methods known in the art.

According to certain illustrative embodiments, the plant material is contacted by liquid via spraying, dripping or any other method known in the art. The liquid can be any desired temperature. Conditions of temperature and pH of the liquid can be controlled to achieve the desired properties. According to certain illustrative embodiments, the liquid has a temperature from about 1° C. to about 60° C. According to certain illustrative embodiments, the liquid has a temperature from about 4° C. to about 40° C. According to certain illustrative embodiments, the liquid has a temperature from about 10° C. to about 25° C. According to certain illustrative embodiments, the liquid has a temperature from about 16° C. to about 20° C. According to certain illustrative embodiments, the temperature of the liquid approximates ambient temperature. According to certain illustrative embodiments, the liquid has a pH from about 3 to about 9. According to certain illustrative embodiments, the liquid has a pH from about 4 to about 8. According to certain illustrative embodiments, the liquid has a pH from about 5 to about 7. According to certain illustrative embodiments, the liquid has a pH of about 7.

According to certain illustrative embodiments, the liquid is contacted with the plant material to a load of front about 0.001 to about 90 weight percent. According to certain illustrative embodiments, the liquid is contacted with the plant material to a load of from about 5 to about 50 weight percent. According to certain illustrative embodiments, the liquid is contacted with the plant material to a load of from about 10 to about 30 weight percent of the plant material comprises the liquid. According to certain illustrative embodiments, the liquid is contacted with the plant material to a load of from about 5 to about 25 weight percent of the plant material comprises the liquid. According to certain illustrative embodiments, the liquid is contacted with the plant material to a load of from about 20 to about 25 weight percent of the plant material comprises the liquid. According to certain illustrative embodiments, the liquid is contacted with the plant material to a load of from about 12 to about 20 weight percent of the plant material comprises the liquid. The above liquid load weight percentages are based on the total weight of the plant material and loaded liquid. The liquid load may be altered depending on the desired properties of the plant material.

According to certain illustrative embodiments, the at least one exogenous vitamin and/or at last one exogenous mineral is contacted with the plant material having one or more opened pores and/or one or mote fractures with or without mixing or agitation.

According to certain illustrative embodiments, the plant material is contacted with the at least one exogenous vitamin and/or at least one exogenous mineral until from about 1 to about 50 weight percent of the plant material has at least one exogenous vitamin and/or at least one exogenous mineral at least partially contained therein. In certain embodiments, the plant material is contacted with the at least one exogenous vitamin and/or at least one exogenous mineral until from about 1 to about 40 weight percent of the plant material has at least one exogenous vitamin and/or at least one exogenous mineral at least partially contained therein. According to certain illustrative embodiments, the plant material is contacted with the at least one exogenous vitamin and/or at least one exogenous mineral until from about 1 to about 30 weight percent of the plant material has at least one exogenous vitamin and/or at least one exogenous mineral at least partially contained therein. According to certain illustrative embodiments, the plant material is contacted with the at least one exogenous vitamin and/or at least one exogenous mineral until from about 1 to about 20 weight percent of the plant material has at least one exogenous vitamin and/or at least one exogenous mineral at least partially contained therein. According to certain illustrative embodiments, the plant material is contacted with the at least one exogenous vitamin and/or at least one exogenous mineral until from about 1 to about 10 weight percent of the plant material has at least one exogenous vitamin and/or at least one exogenous mineral at least partially contained therein. According to certain illustrative embodiments, the plant material is contacted with the at least one exogenous vitamin and/or at least one exogenous mineral until from about 5 to about 30 weight percent of the plant material has at least one exogenous vitamin and/or at least one exogenous mineral at least partially contained therein. According to certain illustrative embodiments, the plant material is contacted with the at least one exogenous vitamin and/or at least one exogenous mineral until from about 5 to about 20 weight percent of the plant material has at least one exogenous vitamin and/or at least one exogenous mineral at least partially contained therein. According to certain illustrative embodiments, the plant material is contacted with the at least one exogenous vitamin and/or at least one exogenous mineral until from about 5 to about 15 weight percent of the plant material has at least one exogenous vitamin and/or at least one exogenous mineral at least partially contained therein. According to certain illustrative embodiments, the plant material is contacted with the at least one exogenous vitamin and/or at least one exogenous mineral until from about 5 to about 10 weight percent of the plant material has at least one exogenous vitamin and/or at least one exogenous mineral at least partially contained therein. The above weight percentages are based on the total weight of the plant material and the at least one exogenous vitamin and/or at least one exogenous mineral.

According to certain illustrative embodiments, the at least one exogenous vitamin and/or at least one exogenous mineral is in dry form and/or wet form. According to certain illustrative embodiments, the at least one exogenous vitamin and/or at least one exogenous mineral is in dry form. According to certain illustrative embodiments, the plant material is contacted with a liquid, and in a subsequent step the plant material is contacted with at least one dry exogenous vitamin and/or at least one dry exogenous mineral. According to certain illustrative embodiments, the plant material is wetted with a liquid in a manner that prevents or mitigates clumping of the plant material, and in a subsequent step the wetted plant material is contacted with at least one dry exogenous vitamin and/or at least one dry exogenous mineral. According to certain illustrative embodiments, plant material is reduced in size to produce plant material fragments, the fragmented and/or sheared plant material is then contacted with a liquid, the fragmented and/or sheared plant material is then contacted with at least one dry exogenous vitamin and/or at least one dry exogenous mineral. According to this embodiment, the vitamin and/or mineral containing liquid enters the leaf fragments through breaks or fractures made during the fragmentation and/or shearing process.

According to certain illustrative embodiments, the closing of one or more of the opened pores to at least partially encapsulate the at least one exogenous vitamin and/or at least one exogenous mineral within one or more of the pores of the plant material comprises drying the plant material.

According to certain illustrative embodiments, the plant material may be dried by at least one of fluid bed dryer, a vertical fluidized bed oven, a horizontal fluidized bed, a convection over, a spray dryer, an impingement dryer, a tray dryer, a heat gun and/or a rotor granulator. A suitable fluid bed dryer is commercially available from GEA Group AG (Düsseldorf, Germany) under the tradename Aeromatic STREA-1. Drying conditions may be adjusted to yield a final treated plant material having a water content of about 1 to about 20 weight percent or less. According to certain illustrative embodiments, a vertical high shear granulator is configured to or otherwise connected to a fluid bed dryer to provide a closed system of granulation, encapsulation and drying.

Without being bound to a particular theory, the drying step acts to decrease the volume of the guard cells which closes one or more pores of a plant material. According to certain illustrative embodiments, the plant material is dried at a temperature range from about 40° C. to about 120° C. for about 30 minutes. According to certain illustrative embodiments, the plant material is dried at a temperature range from about 50° C. to about 110° C. for about 30 minutes. According to certain illustrative embodiments, the plant material is dried at a temperature range from about 70° C. to about 90°0 C. for about 30 minutes. According to certain illustrative embodiments, the plant material is dried at a temperature range of about 90° C. for about 30 minutes.

According to certain illustrative embodiments, the method comprises adding plant material to a mixer or granulator to granulate the plant material to a desired average size, adding water to the mixer or granulator containing the granulated plant material, adding at least one exogenous vitamin and/or at least one exogenous mineral to the mixer or granulator containing the granulated plant material, and drying the plant material.

According to certain illustrative embodiments, the method comprises adding plant material to a mixer or granulator capable of creating high shear conditions to granulate the plant material to a desired average size, spraying water on the granulated plant material in the mixer or granulator, adding at least one exogenous vitamin and/or at least one exogenous mineral to the mixer or granulator containing the granulated plant material, and drying the plant material with a fluid bed dryer.

According to certain illustrative embodiments, the method comprises adding plant material to a mixer or granulator capable of creating high shear conditions to granulate the plant material to a desired average size, mixing for about 60 seconds to about 10 minutes, at mixer speeds from about 100 rpm to about 500 rpm. spraying water on the granulated plant material in the mixer or granulator to a load of from about 10% to about 30%, adding at least one exogenous vitamin and/or at least one exogenous mineral to the mixer or granulator containing the granulated plant material until about 5% to about 25%, of the total weight percent of the plant material comprises at least one exogenous vitamin and/or at least one exogenous mineral at least partially contained therein, and drying the plant material with a table top fluid bed dryer at a temperature from about 50° C. to about 110° C. for about 5 to 30 minutes.

According to certain illustrative embodiments, the method comprises adding plant material to a mixer or granulator capable of creating high shear conditions to granulate the plant material to a desired average size, mixing for about 3 minutes to about 8 minutes at mixer speeds from about 100 rpm to about 350 rpm, spraying water on the granulated plant material in the mixer or granulator to a load of from about 15% to about 25%, adding at least one exogenous vitamin and/or at least one exogenous mineral to the mixer or granulator containing the granulated plant material until about 5% to about 15% of the total weight percent of the plant material comprises at least one exogenous vitamin and/or at least one exogenous mineral at least partially contained therein, and drying the plant material with a table top fluid bed dryer at a temperature from about 50° C. to about 110° C. for about 5 minutes to about 30 minutes.

According to certain illustrative embodiments, the method comprises adding plant material to a mixer or granulator capable of creating high shear conditions to granulate the plant material to a desired average size, mixing for about 5 minutes to about 7 minutes at mixer speeds from about 150 rpm to about 250 rpm, spraying water on the granulated plant material in the mixer or granulator to a load of from about 20% to about 25%, adding at least one exogenous vitamin and/or at least one exogenous mineral to the mixer or granulator containing the granulated plant material until about 8% to about 12% of the total weight percent of the plant material comprises at least one exogenous vitamin and/or at least one exogenous mineral at least partially contained therein, and drying the plant material with a table top fluid bed dryer at a temperature from about 50° C. to about 110° C. for about 5 minutes to about 30 minutes.

It will be understood that the ranges described above will vary depending on factors such as the total quantity of plant material utilized, the speed of the mixer or granulator, and the design of the blades. It is within the skill in the art to optimize these ranges to achieve the desired properties of the plant material and the desired amount of the at least one exogenous vitamin and/or at least one exogenous mineral at least partially contained in the plant material. According to certain illustrative embodiments, the at least one exogenous vitamin and/or at least one exogenous mineral is mixed or otherwise stirred with the plant material. According to certain illustrative embodiments, the at least one exogenous vitamin and/or at least one exogenous mineral is mixed with the plant material inside a granulator. According to certain illustrative embodiments, the at least one exogenous vitamin and/or at least one exogenous mineral is mixed with the plant material inside a high shear granulator.

Also disclosed is an infusion packet for making a beverage. In certain embodiments, the infusion packet contains a desired amount of the plant material having at least one exogenous vitamin and/or at least one exogenous mineral at least partially contained therein. According to certain illustrative embodiments, the infusion packet is contacted with a liquid to extract the at least one exogenous vitamin and/or at least one exogenous mineral from the plant material. According to certain illustrative embodiments, the infusion packet is placed in a liquid to extract the at least one exogenous vitamin and/or at least one exogenous mineral from the plant material and to permit dispersion and diffusion of the extract into the surrounding liquid.

According to certain illustrative embodiments, the infusion packet comprises porous material that allows for a liquid to permeate the packet without allowing insoluble contents to leave the packet. Without limitation, suitable material for the infusion packet include filter paper, nylon mesh, gauze, muslin and nonwoven fabric.

Also disclosed is a beverage pod, cartridge, cup or capsule containing plant material having at least one exogenous vitamin and/or at least one exogenous mineral at least partially contained therein. According to certain embodiments, the beverage pod, cartridge, cup or capsule is configured to be pierced by beverage making machines. Suitable examples of beverage making machines are commercially available through Keurig, Inc. and commonly known as K-Cup machines.

In a first embodiment, provided is a consumable comprising a plant material having at least one exogenous vitamin and/or at least one exogenous mineral at least partially contained within the plant material.

The consumable of either of the first or subsequent embodiments may include plant material having at least one exogenous vitamin and/or at least one exogenous mineral at least partially encapsulated within one or more pores of the plant material.

The consumable of any of the first or subsequent embodiments may include plant material having at least one exogenous vitamin and/or at least one exogenous mineral fully encapsulated within one or more pores of the plant material.

The consumable of the first or subsequent embodiments may include at least one exogenous vitamin and/or at least one exogenous mineral at least partially located within the plant material.

The consumable of either of the first or subsequent embodiments may include plant material having at least one exogenous vitamin and/or at least one exogenous mineral fully located within the plant material.

The consumable of any of the first or subsequent embodiments may include plant material comprising at least one leaf and/or at least one stem.

The consumable of any of the first or subsequent embodiments may include plant material comprising at least one tea leaf and/or at least one tea stem.

The consumable of any of the first or subsequent embodiments may include plant material comprising at least one tea leaf and/or at least one tea stem obtained from the Camellia sinensis plant.

The consumable of any of the first or subsequent embodiments may include plant material comprising black tea, green tea, white tea, yellow tea, Echinacea tea, oolong tea, hibiscus tea or combinations thereof.

The consumable of any of the first or subsequent embodiments may include at least one exogenous vitamin comprising vitamin A, B, C, D, E, K, analogues thereof, derivatives thereof and/or combinations thereof.

The consumable of any of the first or subsequent embodiments may include at least one exogenous vitamin comprising a blend of Vitamin E, Vitamin B1, Vitamin B2, Vitamin B6, Vitamin B9, Vitamin B12, Vitamin C, niacinamide, pantothenic acid and biotin.

The consumable of any of the first or subsequent embodiments may include at least one exogenous mineral comprising calcium, sodium, potassium, phosphorous, magnesium, manganese, copper, zinc, iron, selenium, chromium, molybdenum, or combinations thereof.

The consumable of any of the first or subsequent embodiments may include plant material comprising about 15 weight percent or less of the at least one exogenous vitamin and/or the at least one exogenous mineral at least partially contained therein based on the total weight of the plant material and the at least one exogenous vitamin and/or the at least one exogenous mineral.

The consumable of any of the first or subsequent embodiments may include plant material having a moisture content of about 10 weight percent or less based on the total weight of the plant material.

The consumable of any of the first or subsequent embodiments may include at least one exogenous vitamin and/or at least one exogenous mineral at least partially contained in the plant material in a nutritionally effective amount.

The consumable of any of the first or subsequent embodiments may include a beverage.

The consumable of any of the first or subsequent embodiments may include tea-based drinks.

In a second embodiment, provided is a method for at least partially containing at least one exogenous vitamin and/or at least one exogenous mineral within a plant material comprising:

(A) opening one or more pores of the plant material;

contacting the plant material with at least one exogenous vitamin and/or at least one exogenous mineral to permit the at least one exogenous vitamin and/or at least one exogenous mineral to enter at least a portion of the opened pores of the plant material; and

closing one or more of the opened pores thereby at least partially encapsulating the at least one exogenous vitamin and/or at least one exogenous mineral within one or more pores of the plant material; and/or

(B) creating fractures on and/or in the plant material; and

contacting the plant material with at least one exogenous vitamin and/or at least one exogenous mineral to permit the at least one exogenous vitamin and/or at least one exogenous mineral to enter one or more fractures on and/or in the plant material.

The method of the second embodiment may further include reducing the size of the plant material before opening the one or more pores of the plant material.

The method of either of the second or subsequent embodiments may include reducing the plant material to an average size of from about 100 μm to about 500 μm.

The method of any of the second or subsequent embodiments may include reducing the size of the plant material by high shear granulation.

The method of any of the second or subsequent embodiments may include opening the pores of the plant material by contacting the plant material with a liquid.

The method of any of the second or subsequent embodiments may include opening the pores of the plant material by contacting the plant material with a liquid comprising water, at least one solvent, at least one carrier or combinations thereof.

The method of any of the second or subsequent embodiments may include spraying liquid onto the plant material to a load of about 10 to about 30 weight percent.

The method of any of the second or subsequent embodiments may include closing the pores of the plant material by drying the plant material.

The method of any of the second or subsequent embodiments may include drying the plant material with a fluid bed dryer.

The method of any of the second or subsequent embodiments may include drying the plant material at a temperature range from about 70° C. to about 100° C. for about 5 to about 50 minutes.

In a third embodiment, provided is an infusion packet for making a beverage, wherein the infusion packet contains a plant material having at least one exogenous vitamin and/or at least one exogenous mineral at least partially encapsulated therein.

While the treated plant material, methods for making and utilizing the treated plant material, consumables containing the treated plant material, and infusion packets containing the treated plant material have been described in connection with various embodiments, it is to be understood that other similar embodiments may be used or modifications and additions may be made to the described embodiments for performing the same function. It will be understood that the embodiments described herein are merely illustrative, and that one skilled in the art may make variations and modifications without departing from the spirit and scope of the invention. Further, all embodiments disclosed are not necessarily in the alternative, as various embodiments may be combined to provide the desired result.

1. A plant material comprising a plant material having at least one exogenous vitamin and/or at least one exogenous mineral at least partially encapsulated within the stomata and/or fractures of the plant material.

2. (canceled)

3. The plant material of claim 1, wherein the at least one exogenous vitamin and/or at least one exogenous mineral is fully encapsulated within one or more of the stomata of the plant material.

4. The plant material of claim 1, wherein the at least one exogenous vitamin and/or at least one exogenous mineral is at least partially located within one or more of the fractures in the plant material.

5. The plant material of claim 1, wherein the plant material comprises at least one leaf and/or at least one stem.

6. The plant material of claim 5, wherein the plant material comprises at least one tea leaf and/or at least one tea stem.

7. The plant material of claim 6, wherein the at least one tea leaf and/or at least one tea stem is obtained from the Camellia sinensis plant.

8. The plant material of claim 6, wherein the at least one leaf and/or at least one stem comprises black tea, green tea, white tea, yellow tea, Echinacea tea, oolong tea, hibiscus tea or combinations thereof.

9. The plant material of claim 1, wherein the at least one exogenous vitamin comprises vitamin A, B, C, D, E, K, analogues thereof, derivatives thereof and/or combinations thereof.

10. The plant material of claim 1, wherein the at least one exogenous vitamin comprises a mixture of at least one fat-soluble vitamin and at least one water-soluble vitamin.

11. The plant material of claim 1, wherein the at least one exogenous mineral comprises calcium, sodium, iodine, chloride, boron, potassium, phosphorous, magnesium, manganese, copper, zinc, iron, nickel, tin, vanadium, silicon, selenium, chromium, molybdenum or combinations thereof.

12. The plant material of claim 1, wherein the plant material comprises about 15 weight percent or less of the at least one exogenous vitamin and/or at least one exogenous mineral at least partially contained therein based on the total weight of the plant material and the at least one exogenous vitamin and/or at least one exogenous mineral

13. A consumable beverage comprising the plant material of claim 1.

14. The consumable beverage of claim 13, wherein the beverage comprises tea-based drinks.

15. A method for at least partially containing at least one exogenous vitamin and/or at least one exogenous mineral within a plant material comprising:
(A) (i) opening one or more stomata of the plant material;
(ii) contacting the plant material with at least one exogenous vitamin and/or at least one exogenous mineral to permit the at least one exogenous vitamin and/or at least one exogenous mineral to enter at least a portion of the opened stomata of the plant material; and
(iii) closing one or more of the opened stomata thereby at least partially encapsulating the at least one exogenous vitamin and/or at least one exogenous mineral within one or more stomata pores of the plant material; and/or
(B) (i) creating fractures on and/or in the plant material; and
(ii) contacting the plant material with at least one exogenous vitamin and/or at least one exogenous mineral to permit the at least one exogenous vitamin and/or at least one exogenous mineral to enter one or more fractures on and/or in the plant material.

16. The method of claim 15, further comprising reducing the size of the plant material prior to contacting the plant material the at least one exogenous vitamin and/or at least one exogenous mineral.

17. The method of claim 16, wherein reducing the size of the plant material comprises fluid bed granulation.

18. The method of claim 17, wherein the fluid bed granulation is carried out in a high shear vertical fluid bed granulator.

19. The method of claim 17, wherein the average particle size of the granulated plant material is from 10 micron to 7000 micron.

20. The method of claim 19, wherein the average particle size of the granulated plant material is from 100 micron to 3000 micron.

21. The method of claim 20, wherein at least 50 percent of the granulated plant material has an average particle size from 10 micron to 3000 micron.

22. The method of claim 15, wherein the step of opening the one or more stomata of the plant material comprises increasing the volume of parenchymal guard cells bordering the one or more stomata of the plant material by moving a liquid into the parenchymal guard cells by transporting the liquid across the parenchymal guard cell membrane.

23. The method of claim 15, wherein the step of closing the one or more stomata of the plant material comprises decreasing the volume of parenchymal guard cells bordering the one or more stomata of the plant material by moving a liquid out of the parenchymal guard cells by transporting the liquid across the parenchymal guard cell membrane.

24. The method of claim 15, wherein the step (A)(ii) or (B)(ii) comprises contacting the plant material with at least one dry exogenous vitamin and/or at least one dry mineral.

25. The method of claim 15, wherein the step (A)(ii) or (B)(ii) comprises contacting the plant material with at least one wet exogenous vitamin and/or at least one wet mineral.

26. The method of claim 15, wherein the plant material is dried at a temperature in the range from about 40° C. to about 120° C. for about 30 minutes.

27. The method of claim 26, wherein the plant material is dried at a temperature in the range from about 50° C. to about 110° C. for about 30 minutes.

28. The method of claim 27, wherein the plant material is dried at a temperature in the range from about 70° C. to about 90° C. for about 30 minutes.

29. The plant material of claim 1, wherein the at least one exogenous vitamin added to the plant material has a moisture content of 10 percent or less.

30. The plant material of claim 1, wherein the at least one exogenous mineral added to the plant material has a moisture content of 10 percent or less.

31. The plant material of claim 1, wherein the plant material has a moisture content of 5 percent or less.

32. The plant material of claim 1, wherein the plant material comprises from about 1 to about 25 weight percent of the at least one exogenous vitamin and/or at least one exogenous mineral, based on the total weight of the plant material.

33. The plant material of claim 1, wherein the plant material comprises from about 1 to about 15 weight percent of the at least one exogenous vitamin and/or at least one exogenous mineral, based on the total weight of the plant material.
